(19) United States
(12) Patent Application Publication
(10) Pub. No.: US 2010/0153777 A1
(43) Pub. Date: Jun. 17, 2010

(54) PROGRAM UPDATING SYSTEM HAVING CORRECTION STORAGE UNITS AND METHOD THEREOF

(76) Inventor: Yao-chung Hu, Xindian City (TW)

Correspondence Address: AUSTIN RAPP & HARDMAN, 170 South Main Street, Suite 735, SALT LAKE CITY, UT, 84101, US

(21) Appl. No.: 12/430,421

(22) Filed: Apr. 27, 2009

(30) Foreign Application Priority Data
Dec. 12, 2008 (TW) 097148345

(51) Int. Cl. G06F 11/08; G06F 12/14

(52) U.S. Cl. 714/15; 714/E11.03; 711/104; 711/102; 711/E12.103

(57) ABSTRACT

A program updating system having correction storage units and methods thereof are described. The control unit checks the first setting section of the first storage unit to determine whether the first setting data associated with the second storage unit is stored in the first setting section. When the first setting data is stored in the first setting section, the control unit reads the first setting data and writes the first setting data to the second storage unit. The first setting data includes a first correcting address and a first correcting code corresponding to the first correcting address. The second storage unit stores a first setting data transmitted from the first setting section. The control unit compares an executed address of the original program with the first correcting address. When the executed address is identical to the first correcting address, the control unit replaces a first error code corresponding to the executed address with the first correcting code.

### CLAIM OF PRIORITY

This application claims priority to Taiwanese Patent No. 097148345 filed on Dec. 12, 2008.

### FIELD OF THE INVENTION

The present invention relates to an updating system and method thereof, and more particularly relates to a program updating system having a plurality of correction storage units and method thereof.

### BACKGROUND OF THE INVENTION

With the rapid development of semiconductor manufacturing process, the effective area for the size of circuit components within the integrated circuits (ICs) is shrunk. Specifically, memory cells in the integrated circuits (ICs) are used to store the original program but some errors are in the original program. The integrated circuits (ICs) thus must correct the errors. Conventionally, the ICs utilizes update program stored in external flash memory to replace the original program having errors, as shown in FIG. 1. FIG. 1 is a schematic block diagram of a conventional program updating system 100. The program updating system 100 includes a micro controller 102, read-only memory (ROM) 104, a static random access memory (SRAM) 106, and external flash memory 108.

During the program updating process, the hardware circuit (not shown) sends the update program stored in the flash memory 108 to the program updating system 100. The micro controller 102 totally replaces the original program within the read-only memory (ROM) 104. The static random access memory (SRAM) 106 serves as the temporary memory of the micro controller 102 to perform the original program. However, the micro controller 102 cannot merely correct the errors but update the original program by totally replacing the original program. Therefore, it is time-consuming during the update operation. In addition, the capacity of the flash memory 108 is equal to or greater than the capacity of the read-only memory (ROM) 104, resulting in cost-ineffectiveness. Consequentially, there is a need to develop a novel update system to solve the aforementioned problem.

### SUMMARY OF THE INVENTION

One objective of the present invention is to provide a program updating system having a plurality of correction storage units and method thereof. The present invention utilizes the correction storage units within the program updating system for correcting the error codes of the original program when the program updating system performs the original program. The correction storage units may be the second storage unit within the program updating system and/or a portion of memory section within the program updating system (e.g. the memory section of the third storage unit).

Another objective of the present invention is to provide a program updating system having a plurality of correction storage units and method thereof. The first storage unit outside the program updating system stores the correction codes and has lesser memory capacity. The correction codes are sent to the correction storage unit for correcting the error codes of the original program. In one embodiment, the first storage unit is less than the memory stored in the original program to save the manufacturing cost of the program updating system.

According to the above objectives, the present invention sets forth a program updating system having a plurality of correction storage units and method thereof. The program updating system includes a second storage unit, a third storage unit, a fourth storage unit and a control unit. The control unit couples the first storage unit and the driving module, respectively to the second storage unit, the third storage unit and the fourth storage unit.

The first storage unit has a first setting section and a second setting section. The control unit is used to check the first setting section of the first storage unit to determine whether the first setting data associated with the second storage unit is stored in the first setting section. When the first setting data is stored in the first setting section, the control unit reads the first setting data and writes the first setting data to the second storage unit. The first setting data is composed of a first correcting address and a first correcting code corresponding to the first correcting address.

The second storage unit stores a first setting data transmitted from the first setting section. The third storage unit is used to store the second setting data form the second setting section. The fourth storage unit stores the original program. When the control unit executes the original program, the control unit compares an executed address of the original program with the first correcting address. When the executed address is identical to the first correcting address, the control unit replaces a first error code corresponding to the executed address with the first correcting code.

The correcting address length in the third storage unit represents the memory capacity of the third storage unit is greater than the memory capacity of the second storage unit. The memory capacity of the third storage unit is less than the memory capacity of the fourth storage unit. The memory capacity of the first storage unit is less than the memory capacity of the fourth storage unit.

The method of the present invention includes the steps of:

(a) detecting a first setting section of the first storage unit associated with the second storage unit;

(b) checking the first setting section of the first storage unit to determine whether the first setting data associated with the second storage unit is stored in the first setting section;

(c) reading the first setting data and writing the first setting data to the second storage unit by the control unit when the first setting data is stored in the first setting section, wherein the first setting data comprises a first correcting address and a first correcting code corresponding to the first correcting address;

(d) executing an original program stored in the fourth storage unit; and

(e) comparing an executed address of the original program with the first correcting address by the control unit, wherein when the executed address is identical to the first correcting address, the control unit replaces a first error code corresponding to the executed address with the first correcting code.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram of a conventional program updating system;

FIG. 2 is a schematic block diagram of a program updating system according to one embodiment of the present invention; and

FIGS. 3A-3B are flow charts of program updating method utilized in a program updating system according to one embodiment of the present invention.

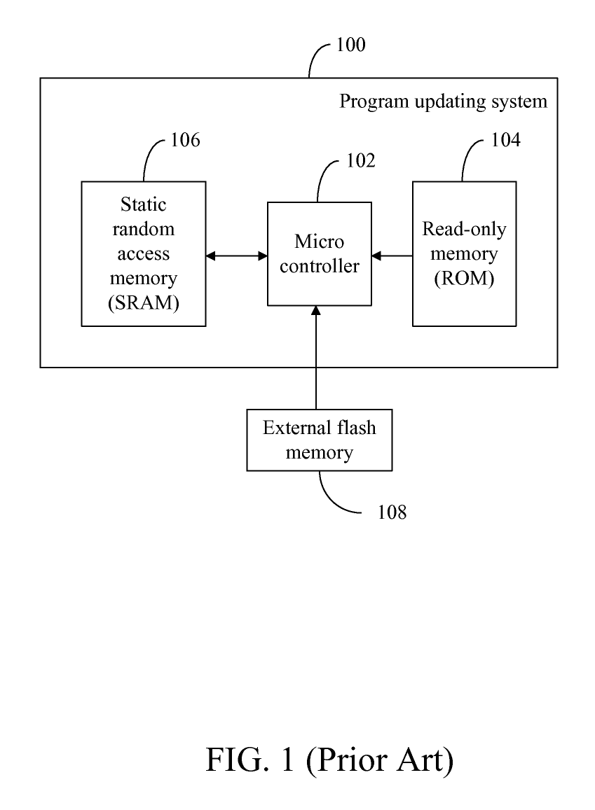

### DETAILED DESCRIPTION OF THE PREFERRED EMBODIMENTS

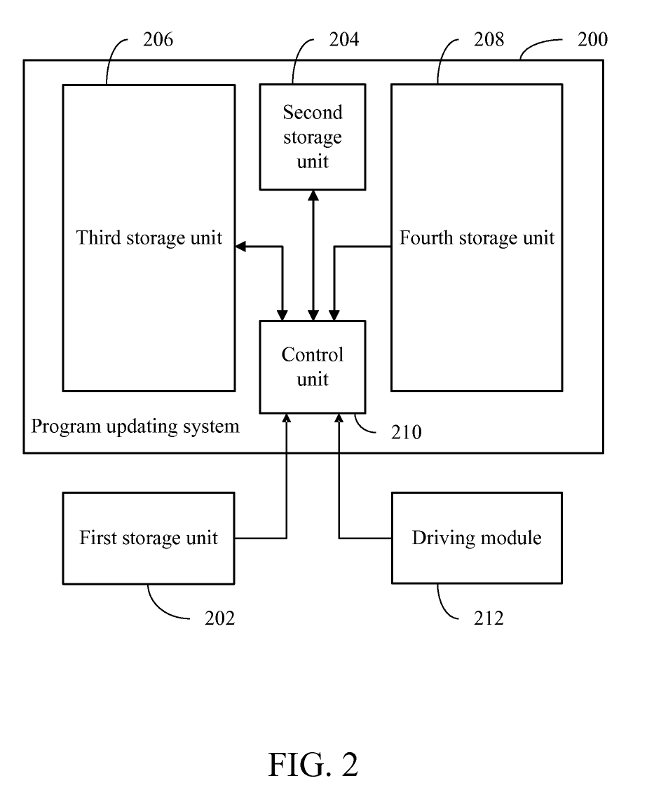

FIG. 2 is a schematic block diagram of a program updating system 200 according to one embodiment of the present invention. The program updating system 200 is coupled to the first storage unit 202 and the driving module 212. The program updating system 200 includes a second storage unit 204, a third storage unit 206, a fourth storage unit 208 and a control unit 210. The control unit 210 couples the first storage unit 202 and the driving module 212, respectively to the second storage unit 204, the third storage unit 206 and the fourth storage unit 208. In one embodiment, the program updating system 200 is a firmware program updating system.

The first storage unit 202 has a first setting section and a second setting section. The control unit 210 is used to check the first setting section of the first storage unit 202 to determine whether the first setting data associated with the second storage unit 204 is stored in the first setting section. When the first setting data is stored in the first setting section, the control unit 210 reads the first setting data and writes the first setting data to the second storage unit 204. The first setting data is composed of a first correcting address and a first correcting code corresponding to the first correcting address.

The second storage unit 204 stores a first setting data transmitted from the first setting section. The third storage unit 206 is used to store the second setting data form the second setting section. The fourth storage unit 208 stores the original program. When the control unit 210 executes the original program, the control unit 210 compares an executed address of the original program with the first correcting address. When the executed address is identical to the first correcting address, the control unit 210 replaces a first error code corresponding to the executed address with the first correcting code.

In one embodiment, the first storage unit 202 is electrically erasable programmable read-only memory (EEPROM) which is compatible to a serial bus. For example, EEPROM is the serial number 24C16 having the capacity of 16 kbits. Such an EEPROM is capable of reducing the pin counts of EEPROM circuits and shrinks the occupied circuit area on the circuit board. For example, the second storage unit 204 may be a register, the third storage unit 206 is a static random access memory (SRAM), and the fourth storage unit 208 is a read-only memory (ROM).

Moreover, the control unit 210 checks the second setting section of the first storage unit 202 to determine whether a second setting data associated with the third storage unit 206 is stored in the second setting section. When the second setting data is stored in the second setting section, the control unit 210 reads the second setting data and writes the second setting data to the third storage unit 206, and the second setting data comprises a correcting address length, an initial correction address and a second correcting code corresponding to the initial correction address calculated by the correcting address length. When the control unit 210 compares the executed address of the original program with the initial correction address, and the executed address is identical to the initial correction address, the control unit 210 replaces a second error code corresponding to the executed address with the second correcting code.

The correcting address length in the third storage unit 206 represents the memory capacity of the third storage unit 206 is greater than the memory capacity of the second storage unit 204. The memory capacity of the third storage unit 206 is less than the memory capacity of the fourth storage unit 208. The memory capacity of the first storage unit 202 is less than the memory capacity of the fourth storage unit 208. Such a structure is capable of reducing the pin counts of the first storage unit 202 to decrease the manufacturing cost of the program updating system 200. Further, the occupied circuit area of the first storage unit 202 on the circuit board is shrunk.

In one embodiment, the data format of first setting section in the first storage unit 202 is the first byte for setting the amount of registers of the second storage unit 204. The capacity of one register may be three bytes. From second byte to 25^{th} byte is used to write the first setting data to the second storage unit 204 and includes eight registers which is the capacity of 24 bytes. The 26^{th} and 27^{th} bytes are the correcting address length of the second setting data in the third storage unit 206. Form the 28^{th} byte to last byte of the first storage unit 202 is the codes to be written to the third storage unit 206.

In the original program, data “0×55” (i.e. error code) is written to the address “C029”. The memory mapping address of the original program is located in the address “0016”, as shown in the following table:

| | | |
|---|---|---|
| Address | Codes | Program Description |

| | | | |
|---|---|---|---|
| 0012 | 90C029 | MOV | DPTR, #0C029H |
| 0015 | 7455 | MOV | A, #055H |
| 0017 | F0 | MOVX | @DPTR, A |

The data “0×AA” has to be written to the address “C029” for a correct program, as shown in the following table:

| | | |
|---|---|---|
| Address | Codes | Program Description |

| | | | |
|---|---|---|---|
| 0012 | 90C029 | MOV | DPTR, #0C029H |
| 0015 | 74AA | MOV | A, #0AAH |
| 0017 | F0 | MOVX | @DPTR, A |

For example, the content of the first storage unit 202 includes:

First byte: the setting amount of the register is one set (01).

Second byte and third byte: the desired correction address in the fourth storage unit 208 is “0016”.

Fourth byte: the corrected code is “AA”.

While the control unit 210 executes the original program stored in the fourth storage unit 208, the codes in the original program are executed from address ‘00” to address “12”. The addresses “0012”, “0013”, “0014”, and “0015” are different from the registers 1 and 2 (i.e. desired correction address “0016”). Therefore, desired execution codes are “90, C0, 29, 74”. Afterwards, while the code in the address “16” is executed and the address “16” is the same as the registers 1 and 2 of the second storage unit 204, the control unit 210 replaces the code of address “16” in the original program with code “AA” of register 3. Thus, the control unit 210 writes the data “0×AA” to the address “C029”.

In the original program, data “0×55” (i.e. error code) is written to the address “C029”. The memory mapping address of the original program is located in the address “0012”, as shown in the following table:

| | | |
|---|---|---|
| Address | Codes | Program Description |

| | | | |
|---|---|---|---|
| 0012 | 90C029 | MOV | DPTR, #0C029H |
| 0015 | 7455 | MOV | A, #055H |
| 0017 | F0 | MOVX | @DPTR, A |

For example, the content of the first storage unit 202 includes:

26^{th}, 27^{th} bytes: the correcting address length of the third storage unit 206.

After the 28^{th} bytes: the codes written to the third storage unit 206 are “02 F8 00 90 C0 29 74 AA F00200 18”.

The corrected program: the control unit 210 jumps to the initial correction address of the third storage unit 206. The control unit reads the codes of the third storage unit 206. The data “0×AA” is written to the address “C029”.

| | | |
|---|---|---|
| Address | Codes | Program Description |

| | | | |
|---|---|---|---|
| 0012 | 02F800 | LJMP | ?F800 |
| F800 | 90C029 | MOV | DPTR, #0C029H |
| F803 | 74AA | MOV | A, #0AAH |
| F805 | F0 | MOVX | @DPTR, A |
| 0012 | 020018 | LJMP | ?0018 |

Finally, the control unit 210 jumps back to the corrected address of the original program in fourth storage unit 208.

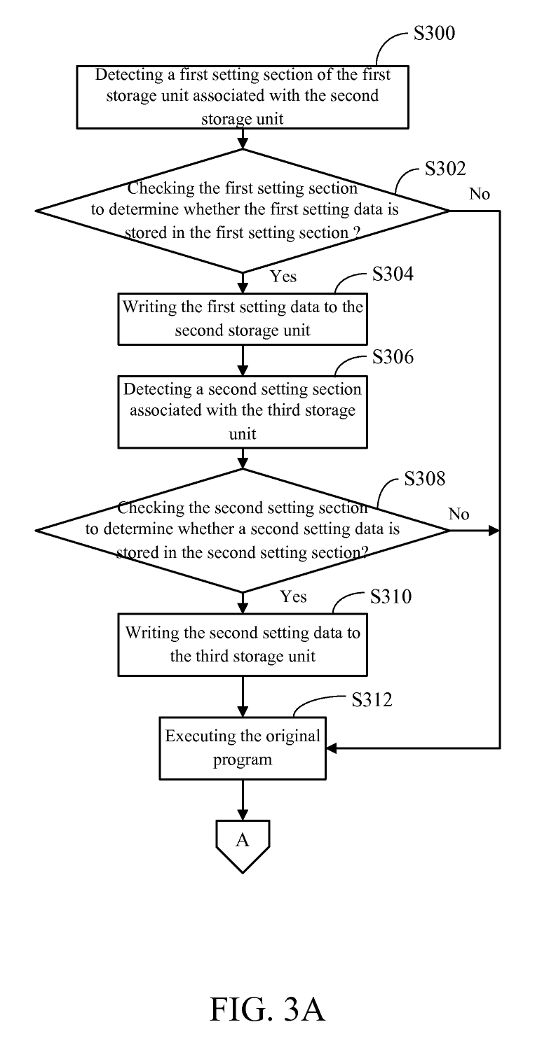

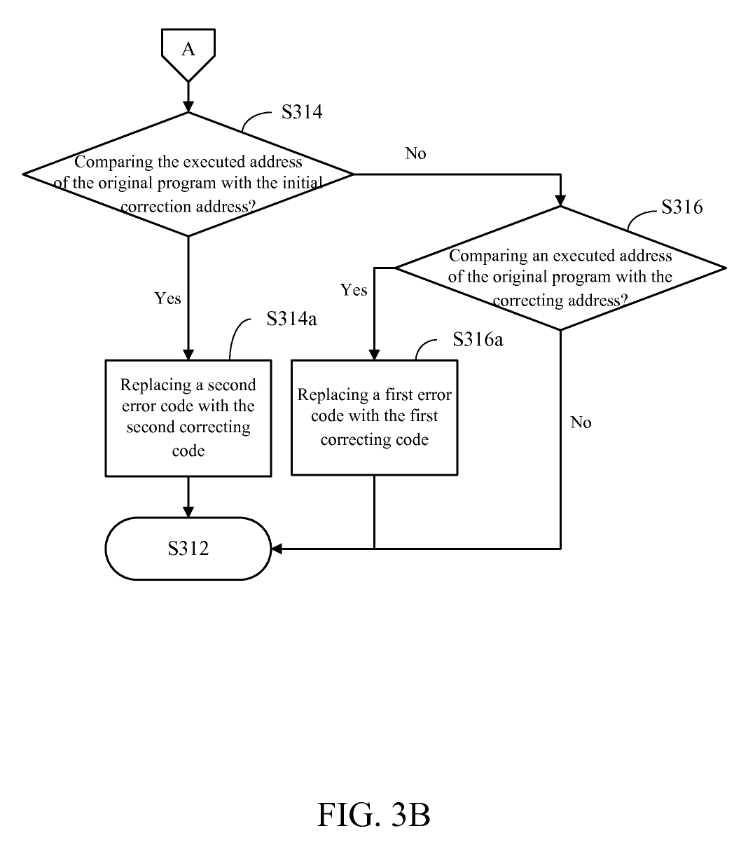

Please refer to FIG. 2 and 3A-3B. FIGS. 3A-3B are flow charts of program updating method utilized in a program updating system 200 according to one embodiment of the present invention. The program updating method is performed in the program updating system 200. The program updating system 200 is coupled to the first storage unit 202. The program updating system 200 includes a second storage unit 204, a third storage unit 206, a fourth storage unit 208 and a control unit 210. The correcting address length in the third storage unit 206 represents the memory capacity of the third storage unit 206 is greater than the memory capacity of the second storage unit 204. The memory capacity of the third storage unit 206 is less than the memory capacity of the fourth storage unit 208. The memory capacity of the first storage unit 202 is less than the memory capacity of the fourth storage unit 208.

The method comprising the steps of:

In step S300, the control unit 210 detects a first setting section of the first storage unit 202 associated with the second storage unit 204.

In step S302, the control unit 210 checks the first setting section of the first storage unit 202 to determine whether the first setting data associated with the second storage unit 204 is stored in the first setting section.

In step S304, when the first setting data is stored in the first setting section, the control unit 210 reads the first setting data and writes the first setting data to the second storage unit 204. The first setting data includes a first correcting address and a first correcting code corresponding to the first correcting address. When the first setting section has no the first setting data, the control unit 210 continuously executes the original program. That is, the control unit 210 performs the step S312.

In step S306, the control unit 210 detects a second setting section of the first storage unit 202 associated with the third storage unit 206.

In step S308, the control unit 210 checks the second setting section of the first storage unit 202 to determine whether a second setting data associated with the third storage unit 206 is stored in the second setting section.

In step S310, the control unit 210 reads the second setting data and writes the second setting data to the third storage unit 206 when the second setting data is stored in the second setting section. The second setting data includes a correcting address length, an initial correction address and a second correcting code corresponding to the initial correction address calculated by the correcting address length. When the second setting section has no the second setting data, the control unit 210 continuously executes the original program. That is, the control unit 210 performs the step S312.

In step S312, the control unit 210 executes the original program stored in the fourth storage unit 208.

In step S314, the control unit 210 compares the executed address of the original program with the initial correction address. When the executed address is identical to the initial correction address, the control unit 210 replaces a second error code corresponding to the executed address with the second correcting code, as shown in step S314a. Return step S312. The step S316 is performed when the executed address is different from the initial correction address.

In step S316, the control unit 210 compares an executed address of the original program with the first correcting address. When the executed address is identical to the first correcting address, the control unit 210 replaces a first error code corresponding to the executed address with the first correcting code, as shown in step S316a. The control unit 210 executes a program code corresponding to the executed address when the executed address is different from the correcting address. Return step S312.

According to the above-mentioned descriptions, the present invention utilizes the correction storage units within the program updating system for correcting the error codes of the original program when the program updating system performs the original program. The correction storage units may be the second storage unit within the program updating system and/or a portion of memory section within the program updating system (e.g. the memory section of the third storage unit). The first storage unit outside the program updating system stores the correction codes and has lesser memory capacity. The correction codes are sent to the correction storage unit for correcting the error codes of the original program. In one embodiment, the first storage unit is less than the memory stored in the original program to save the manufacturing cost of the program updating system.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A program updating system having a plurality of correction storage units, the program updating system comprising:
a first storage unit having a first setting section;
a second storage unit, for storing a first setting data transmitted from the first setting section;
a control unit coupled to the first storage unit, for checking the first setting section of the first storage unit to determine whether the first setting data associated with the second storage unit is stored in the first setting section, wherein when the first setting data is stored in the first setting section, the control unit reads the first setting data and writes the first setting data to the second storage unit, and the first setting data comprises a first correcting address and a first correcting code corresponding to the first correcting address; and
a fourth storage unit, for storing an original program;
wherein when the control unit executes the original program, the control unit compares an executed address of the original program with the first correcting address, and when the executed address is identical to the first correcting address, the control unit replaces a first error code corresponding to the executed address with the first correcting code.

2. The program updating system of claim 1, wherein the first storage unit further comprises a second setting section.

3. The program updating system of claim 2, wherein the control unit further comprises a third storage unit.

4. The program updating system of claim 3, wherein the control unit checks the second setting section of the first storage unit to determine whether a second setting data associated with the third storage unit is stored in the second setting section.

5. The program updating system of claim 4, wherein when the second setting data is stored in the second setting section, the control unit reads the second setting data and writes the second setting data to the third storage unit, and the second setting data comprises a correcting address length, an initial correction address and a second correcting code corresponding to the initial correction address calculated by the correcting address length.

6. The program updating system of claim 5, wherein when the control unit compares the executed address of the original program with the initial correction address, and when the executed address is identical to the initial correction address, the control unit replaces a second error code corresponding to the executed address with the second correcting code.

7. The program updating system of claim 5, wherein the correcting address length in the third storage unit represents the memory capacity of the third storage unit is greater than the memory capacity of the second storage unit, and the memory capacity of the third storage unit is less than the memory capacity of the fourth storage unit.

8. The program updating system of claim 3, wherein the third storage unit is a static random access memory (SRAM).

9. The program updating system of claim 1, wherein the memory capacity of the first storage unit is less than the memory capacity of the fourth storage unit.

10. The program updating system of claim 1, wherein the first storage unit is a non-volatile memory.

11. The program updating system of claim 1, wherein the second storage unit is a register.

12. The program updating system of claim 1, wherein the fourth storage unit is a read-only memory (ROM).

13. A program updating method for a program updating system, wherein the program updating system is coupled to a first storage unit and the program updating system comprises a second storage unit, a third storage unit, a fourth storage unit and a control unit, the method comprising the steps of:
(a) detecting a first setting section of the first storage unit associated with the second storage unit;
(b) checking the first setting section of the first storage unit to determine whether the first setting data associated with the second storage unit is stored in the first setting section;
(c) reading the first setting data and writing the first setting data to the second storage unit by the control unit when the first setting data is stored in the first setting section, wherein the first setting data comprises a first correcting address and a first correcting code corresponding to the first correcting address;
(d) executing an original program stored in the fourth storage unit; and
(e) comparing an executed address of the original program with the first correcting address by the control unit, wherein when the executed address is identical to the first correcting address, the control unit replaces a first error code corresponding to the executed address with the first correcting code.

14. The method of claim 13, after the step (c), further comprising the steps:
(c1) detecting a second setting section of the first storage unit associated with the third storage unit;
(c2) checking the second setting section of the first storage unit to determine whether a second setting data associated with the third storage unit is stored in the second setting section; and
(c3) reading the second setting data and writing the second setting data to the third storage unit by the control unit when the second setting data is stored in the second setting section, wherein the second setting data comprises a correcting address length, an initial correction address and a second correcting code corresponding to the initial correction address calculated by the correcting address length.

15. The method of claim 14, after the step (e), further comprising the step (f): comparing the executed address of the original program with the initial correction address by the control unit, wherein when the executed address is identical to the initial correction address, the control unit replaces a second error code corresponding to the executed address with the second correcting code.

16. The method of claim 15, during the step (f), further comprising a step of executing a program code corresponding to the executed address when the executed address is different from the initial correction address.

17. The method of claim 14, during the step (c3), further comprising a step of continuously executing the original program in step (d) when the second setting section has no the second setting data.

18. The method of claim 13, during the step (b), further comprising a step of continuously executing the original program in step (d) when the first setting section has no the first setting data.

19. The method of claim 13, during the step (e), further comprising a step of executing a program code corresponding to the executed address when the executed address is different from the correcting address.
